(19) United States
(12) Patent Application Publication
(10) Pub. No.: US 2006/0182511 A1
(43) Pub. Date: Aug. 17, 2006

(54) Mounting device

(76) Inventor: Roger Dessureau, West Hartford, CT (US)

Correspondence Address: THE LAW OFFICES OF STEVEN MCHUGH, LLC, 46 WASHINGTON STREET, MIDDLETOWN, CT, 06457, US

(21) Appl. No.: 11/056,319

(22) Filed: Feb. 11, 2005

(51) Int. Cl. F16B 13/04

(52) U.S. Cl. 411/38

(57) ABSTRACT

A mounting device assembly is provided and includes a mounting device having a support structure associated with a mounting structure, wherein the support structure includes a support structure length and a plurality of support threads, the plurality of support threads traversing at least a portion of the support structure and wherein the mounting structure includes a mounting structure length and a plurality of mounting threads, the plurality of mounting threads traversing at least a portion of the mounting structure, wherein the mounting structure is at least one of larger and smaller than the support structure and an expansion sleeve, wherein the expansion sleeve includes a sleeve structure defining a threaded opening associated with a non-threaded opening via a plurality of longitudinal members, the threaded opening being sized and shaped to threadingly interact with the support threads.

### FIELD OF THE INVENTION

This disclosure relates generally to mounting an object to a support structure and more particularly to a device for mounting an object to a support structure.

### BACKGROUND OF THE INVENTION

Devices for mounting an object, such as a decorative knob and/or a picture frame, to a support structure, such as a wall, are well known in the art and include device designs that span the range of simple to relatively complex. For example, one such design includes an expansion sleeve used in conjunction with a mounting screw to anchor the mounting screw to a support structure, wherein an object is secured to the support structure via the mounting screw. Referring to FIG. 1, this expansion sleeve design is shown and includes an expansion sleeve 100 having at least one stabilizing member 102, a non-threaded opening 104 communicated with a threaded opening 106 via an expansion sleeve cavity 108, wherein expansion sleeve cavity 108 is defined by a plurality of longitudinal members 110. Non-threaded opening 104 is disposed to receive a threaded mounting screw 112 for supporting an object, such as a picture 113, into the expansion sleeve cavity 108 to allow the threaded screw 112 to traverse the expansion sleeve cavity 108 and interact with threaded opening 106.

Referring to FIG. 2 and FIG. 3, the anchoring of the expansion sleeve 100 in a mounting hole of a support structure 116, such as a sheet rock wall 118, is generally attained by drilling a mounting hole 120 into the sheet rock wall 118 and inserting the expansion sleeve 100 into the mounting hole 120 such that the stabilizing members 102 interact with the sheet rock wall 118 to prevent expansion sleeve 100 from rotating relative to sheet rock wall 118. The threaded mounting screw 112 is inserted into expansion sleeve cavity 108 via non-threaded opening 104 to be communicated with threaded opening 106. The threaded mounting screw 112 is the rotated relative to expansion sleeve cavity 108 such that threaded mounting screw 112 threadingly interacts with threaded opening 106 causing threaded opening 106 to move toward non-threaded opening 104. As the distance between threaded opening 106 and non-threaded opening 104 decreases each of the plurality of longitudinal members 110 bend at a predetermined location along its length L in a scissors fashion to form at least one longitudinal elbow 124, thus increasing the width W of the expansion sleeve 100. This anchors the expansion sleeve 100 to the support structure 116, thus allowing the expansion sleeve 100 to support an object.

Unfortunately however, although these expansion sleeves 100 come in varying sizes in an attempt to accommodate different size mounting screws and loads, it is often the case that the expansion sleeves 100 do not accommodate the varying sizes of the mounting screws used in conjunction with other support elements such as, but not limited to, decorative knobs and drawer pulls.

### SUMMARY OF THE INVENTION

The above discussed deficiencies and other drawbacks are overcome or alleviated by a mounting device which includes a support structure, wherein the support structure further includes a support structure length and a plurality of support threads, the plurality of support threads traversing at least a portion of the support structure and a mounting structure, wherein the mounting structure includes a mounting structure length and a plurality of mounting threads, the plurality of mounting threads traversing at least a portion of the mounting structure.

Additionally, a mounting device assembly is provided and includes a mounting device having a support structure associated with a mounting structure, wherein the support structure includes a support structure length and a plurality of support threads, the plurality of support threads traversing at least a portion of the support structure and wherein the mounting structure includes a mounting structure length and a plurality of mounting threads, the plurality of mounting threads traversing at least a portion of the mounting structure, wherein the mounting structure is at least one of larger and smaller than the support structure and an expansion sleeve, wherein the expansion sleeve includes a sleeve structure defining a threaded opening associated with a non-threaded opening via a plurality of longitudinal members, the threaded opening being sized and shaped to threadingly interact with the support threads.

### BRIEF DESCRIPTION OF DRAWINGS

The foregoing and other features and advantages of the present invention will be more fully understood from the following detailed description of illustrative embodiments, taken in conjunction with the accompanying drawings in which like elements are numbered alike:

FIG. 1 is a side view of a disengaged expansion sleeve and a mounting screw for mounting objects to a support structure, in accordance with the prior art;

FIG. 2 is a side view of the expansion sleeve and mounting screw of FIG. 1 with the expansion sleeve partially engaged for mounting objects to a support structure;

FIG. 3 is a side view of the expansion sleeve and mounting screw of FIG. 1 with the expansion sleeve fully engaged for mounting objects to a support structure;

FIG. 4 is a front view of an object being secured to a support structure via the expansion sleeve and mounting screw of FIG. 1;

FIG. 5 is a side view of a one embodiment of a mounting device, in accordance with an exemplary embodiment;

FIG. 6 is a side view of a second embodiment of the mounting device of FIG. 5;

FIG. 7 is a side view of a third embodiment of the mounting device of FIG. 5;

FIG. 8 is a side view of a mounting device assembly, in accordance with an exemplary embodiment, with the mounting device of FIG. 5;

FIG. 9 is a side view of the mounting device assembly of FIG. 8;

FIG. 10 is a side view of the mounting device assembly of FIG. 8; and

FIG. 11 is a side view of the mounting device assembly of FIG. 8.

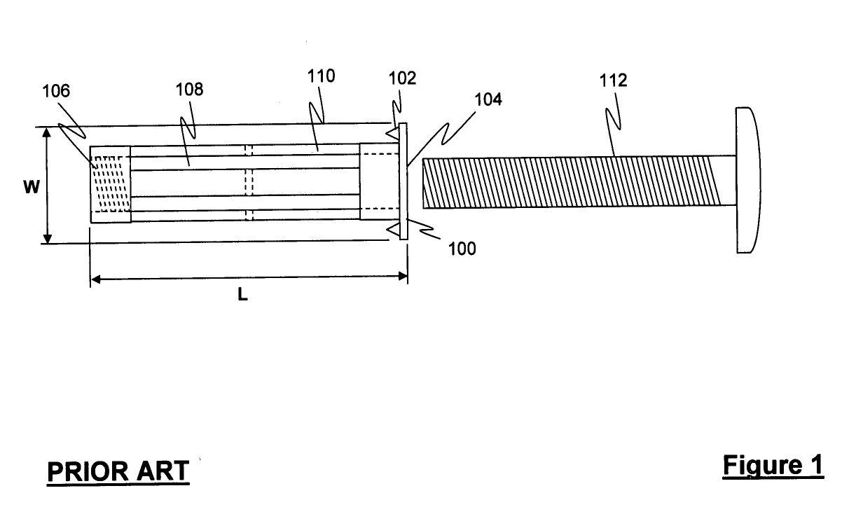

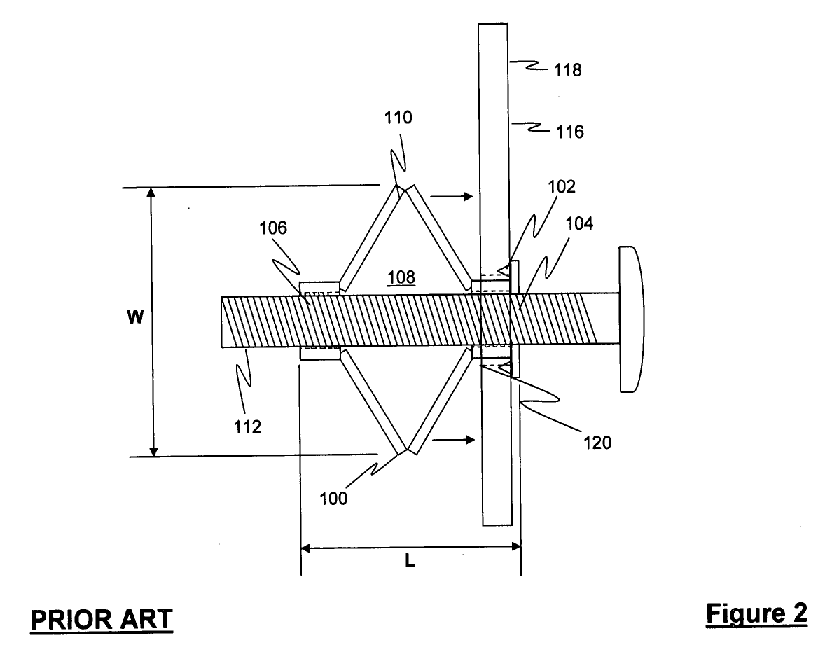

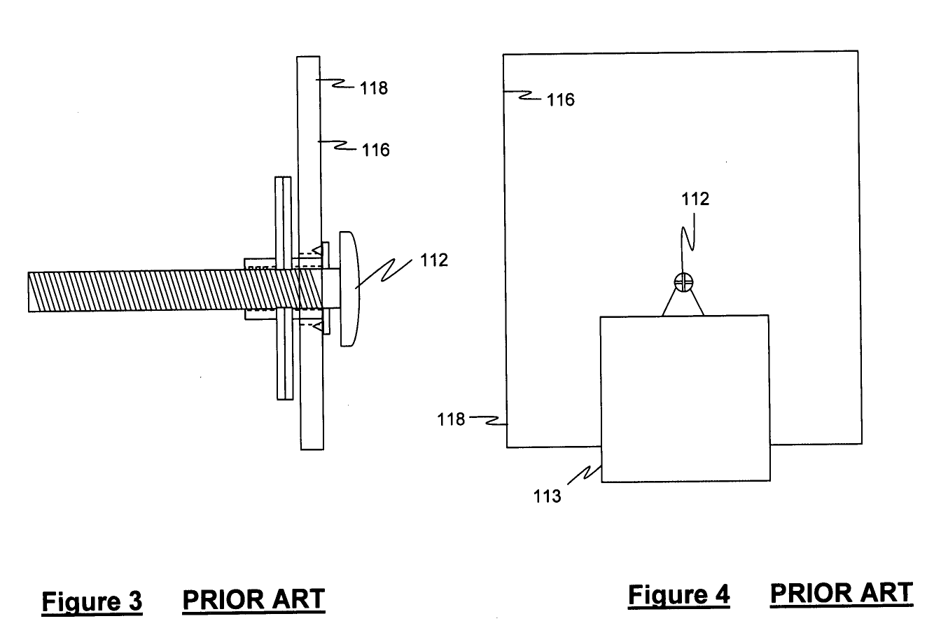

### DETAILED DESCRIPTION OF THE INVENTION

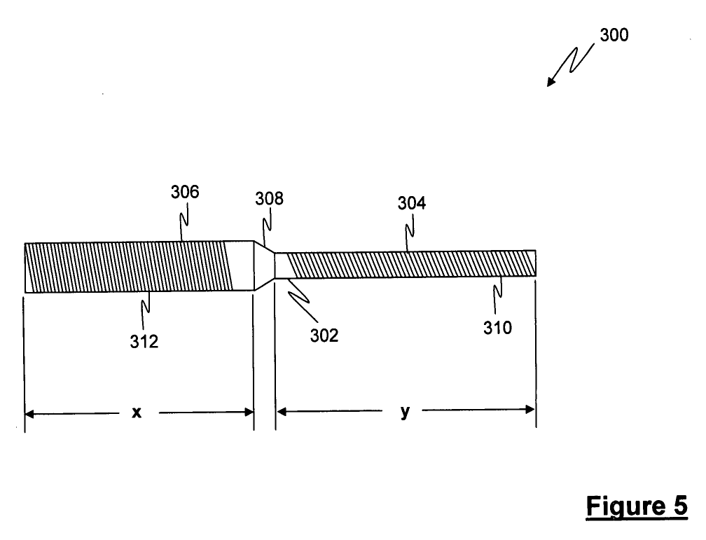

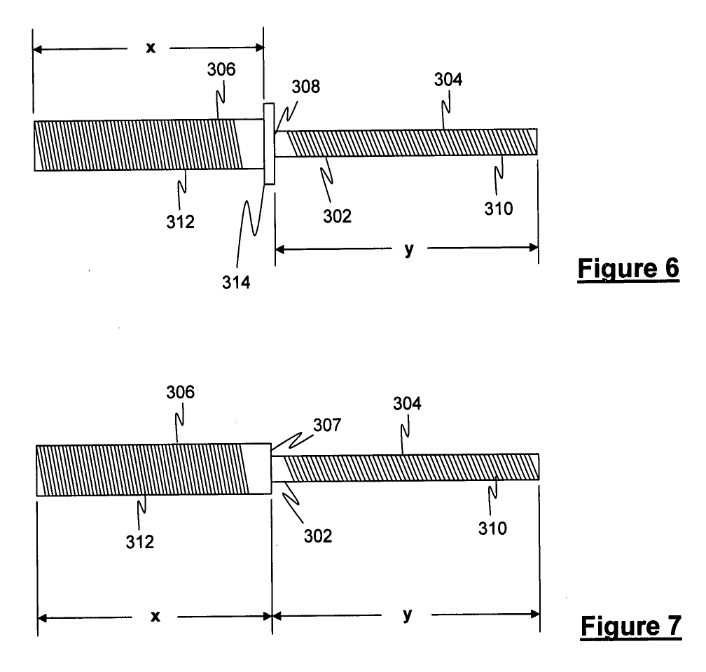

Referring to FIG. 5, a mounting device 300 for use with an expansion sleeve 100 is shown and includes a device structure 302 having a support structure 304 separated from a mounting structure 306 via a transition structure 308. Support structure 304 includes a support structure length x and a plurality of support threads 310 traversing at least a portion of support structure length x. Similarly, mounting structure 306 includes a mounting structure length y and a plurality of mounting threads 312 traversing at least a portion of mounting structure length y. Although transition structure 308 is shown as being a sloped portion to gradually transition between the support structure 304 and the mounting structure 306, transition structure 308 may be any transition structure 308 suitable to the desired end purpose, such as a washer like abutment device 314, as shown in FIG. 6. Additionally, it should be appreciated that mounting device 300 may not include a transition structure 308 such that support structure 304 is directly communicated with mounting structure 306 to form a structure lip 307 between support structure 304 and mounting structure 306, as shown in FIG. 7.

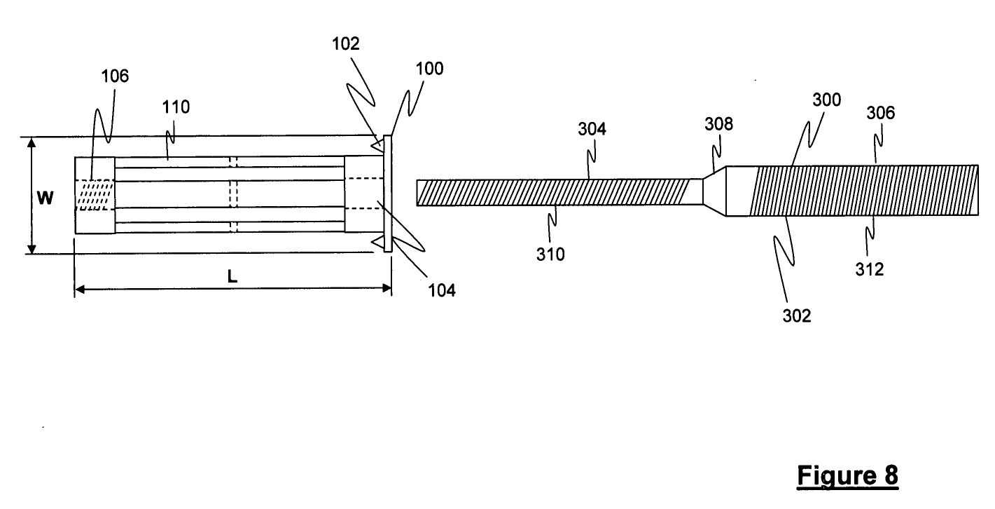

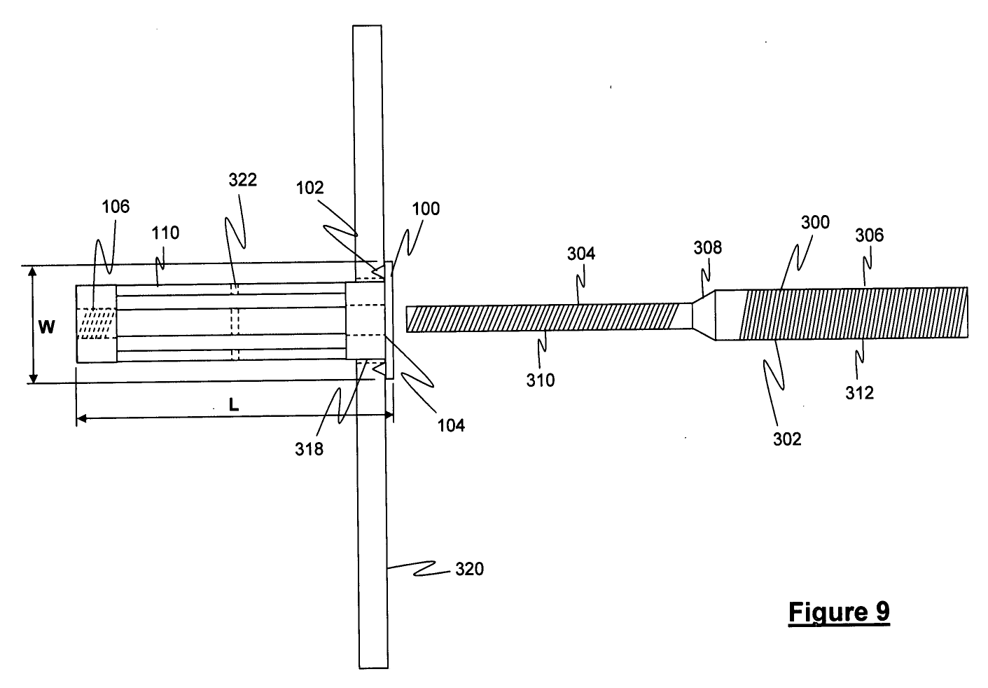

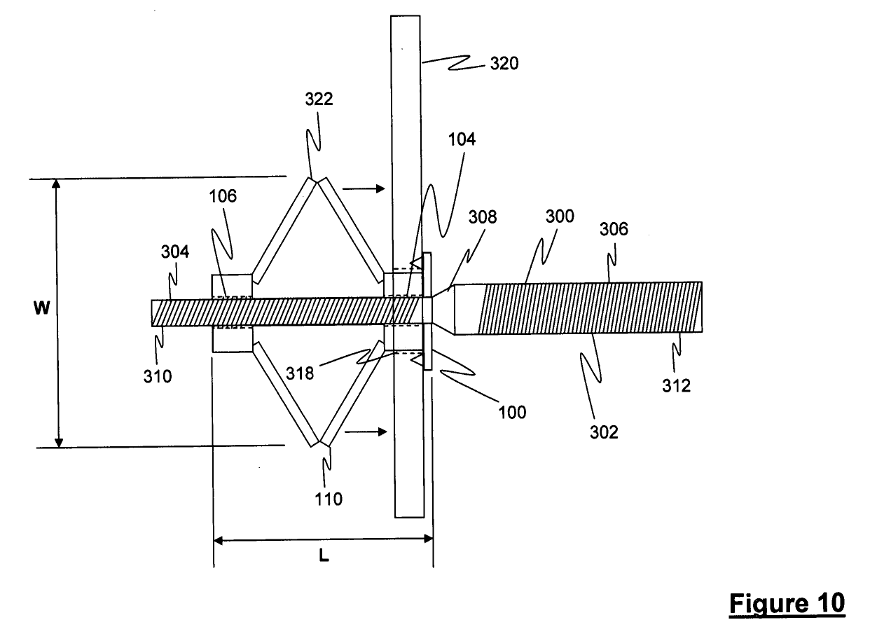

Referring to the figures, mounting device 300 may be implemented as follows. Referring to FIG. 8, a mounting device 300 and an expansion sleeve 100 is shown wherein mounting device 300 includes mounting structure 306 separated from support structure 304 via transition structure 308. Expansion sleeve 100 includes threaded opening 106, non-threaded opening 104 and plurality of longitudinal members 110. It should be appreciated that threaded opening 106 is sized and shaped to threadingly interact with the plurality of support threads 310 on support structure 304. Referring to FIG. 9, expansion sleeve 100 is shown inserted into a hole 318 drilled into a wall 320 such that stabilizing members 102 interact with wall 320 to prevent expansion sleeve 100 from rotating relative to wall 320. Referring to FIG. 10, support structure 304 of mounting device 300 is associated with threaded opening 106 by inserting support structure into non-threaded opening 104 and rotating mounting device 300 such that threaded opening 106 and plurality of support threads 310 interact with each other. As threaded opening 106 and plurality of support threads 310 interact with each other, the distance between threaded opening 106 and non-threaded opening 104 decreases and the plurality of longitudinal members 110 bend at predetermined locations 322 in a scissors fashion.

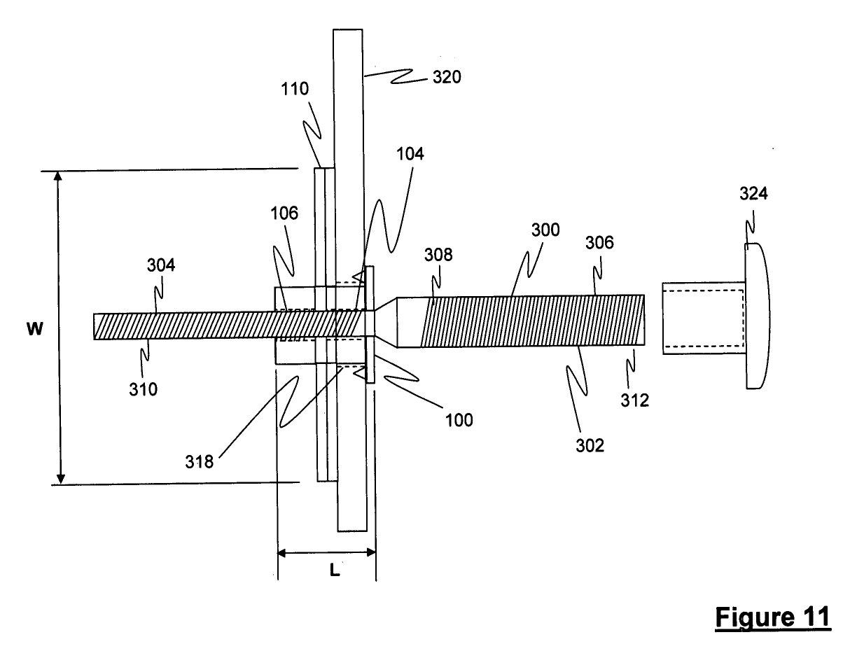

Referring to FIG. 11, as mounting device 300 continues to be rotated, the distance between threaded opening 106 and non-threaded opening 104 decreases to a minimum value and the plurality of longitudinal members 110 are disposed adjacent the inner side of wall 320. It should be appreciated that at this point, the width of the plurality of longitudinal members 110 is larger than the width of the hole 318 that was drilled into wall 320. This prevents expansion sleeve 100 from being removed from the hole 318 and acts to support mounting device 300 which is disposed within expansion sleeve 100. An object 324 or decorative element may then be supportingly associated with mounting structure 306.

It should be appreciated that the support structure 304, the plurality of support threads 310, the mounting structure 306 and/or the plurality of mounting threads 312 may be of different and/or varying sizes and shapes to accommodate different types of objects or decorative elements. Moreover, it should be appreciated that mounting device 300 may be constructed from any material suitable to the desired end purpose, such as steel, brass, aluminum, plastic and or any combination thereof.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

1. A mounting device, comprising:
a support structure, wherein said support structure includes a support structure length and a plurality of support threads, said plurality of support threads traversing at least a portion of said support structure;
a mounting structure, wherein said mounting structure includes a mounting structure length and a plurality of mounting threads, said plurality of mounting threads traversing at least a portion of said mounting structure; and
a transition structure, said transition structure being disposed to separate said support structure and said mounting structure.

2. (canceled)

3. The mounting device of claim 1, wherein at least one of said support structure and said mounting structure is larger in diameter than the other of said support structure and said mounting structure.

4. The mounting device of claim 1, wherein at least one of said plurality of support threads and said plurality of mounting threads is larger than the other of said plurality of support threads and said plurality of mounting threads.

5. The mounting device of claim 1, wherein at least a portion of said mounting device is constructed from at least one of a metallic material and a plastic material.

6. A mounting device assembly, comprising:
a mounting device having a support structure associated with a mounting structure via a transition structure, wherein said transition structure separates said support structure and said mounting structure and wherein said support structure includes a support structure length and a plurality of support threads, said plurality of support threads traversing at least a portion of said support structure and wherein said mounting structure includes a mounting structure length and a plurality of mounting threads, said plurality of mounting threads traversing at least a portion of said mounting structure, wherein said mounting structure is at least one of larger and smaller than said support structure; and
an expansion sleeve, wherein said expansion sleeve includes a sleeve structure defining a threaded opening associated with a non-threaded opening via a plurality of longitudinal members, said threaded opening being sized and shaped to threadingly interact with said support threads.

7. (canceled)

8. The mounting device of claim 6, wherein at least one of said support structure and said mounting structure is larger in diameter than the other of said support structure and said mounting structure.

9. The mounting device of claim 6, wherein at least one of said plurality of support threads and said plurality of mounting threads is larger than the other of said plurality of support threads and said plurality of mounting threads.

10. The mounting device of claim 6, wherein at least a portion of said mounting device assembly is constructed from at least one of a metallic material and a plastic material.
